(19) United States
(12) Patent Application Publication
(10) Pub. No.: US 2014/0279595 A1
(43) Pub. Date: Sep. 18, 2014

(54) REVIEWING ADVERTISEMENT COMPONENTS FOR COMPLIANCE WITH POLICIES OF AN ONLINE SYSTEM

(71) Applicant: Facebook, Inc., Menlo Park, CA (US)

(72) Inventors: Nuwan Senaratna, Sunnyvale, CA (US); Austin Byrne, Austin, TX (US)

(73) Assignee: Facebook, Inc., Menlo Park, CA (US)

(21) Appl. No.: 13/802,405

(22) Filed: Mar. 13, 2013

(51) Int. Cl. G06Q 30/00

(52) U.S. Cl. CPC G06Q 30/018
USPC 705/317

(57) ABSTRACT

An advertisement is received by an online system, which divides the advertisement into components. The online system determines whether the components satisfy one or more policies of the online system. Tags may be associated with components of the advertisement that describe characteristics of the component. Tags are compared to one or more advertisement rules from a policy to determine if a component corresponding to the tags satisfies the policy. The online system may notify advertisers of advertisement components that do not satisfy the a policy of the online system to allow the advertiser to more easily modify advertisements for subsequent compliance.

### BACKGROUND

This invention relates to online systems and in particular to reviewing advertisements in an online system.

A large number of online systems derive revenue by showing advertisements to their users. Advertisements allow advertisers, or other providers, to obtain public attention to their products, services, opinions, or causes. Presenting advertisements allows advertisers to persuade persons viewing the advertisement to respond in a certain way to advertised products, services, or other information. Providers advertising their products, services, opinions, or causes in the online system may manually create an advertisement through a web page provided by the online system or automatically create an advertisement through an application programming interface (API).

Many online systems specify certain policies for advertisements to comply with before being presented by an online system. Over time, the online system may change one or more of the policies applied to advertisements. Changes to a policy applied to an advertisement modify review of advertisements by the online system, affecting which advertisements are presented to users. In conventional online systems, changing a policy applied to advertisement requires manually specifying the modified policy to the online system or additional training for reviews manually reviewing advertisements. Hence, changing a policy applied to advertisements may be expensive and time-consuming for online systems.

### SUMMARY

An online system generates revenue by presenting advertisements to its users. To enhance user interaction with the online system, advertisements presented by the online system are often limited to advertisements satisfying certain requirements or policies. However, these requirements or policies may change over time. To resource the time and resources consumed by changing a policy applied to advertisements, the online system divides advertisements into components and separately reviews each component of an advertisement. The online system associates tags with each component of an advertisement. In some embodiments, the tags are policy independent and do not change when a policy of the online system changes. A tag describes characteristics of a corresponding component and do not indicate whether the component complies with a policy of the online system.

To review an advertisement for compliance with policies, the online system applies rules from one or more policies applicable to various components of the advertisement. The one or more policies, which specify a complete set of rules applicable to the advertisement, are then applied to the advertisement. In some embodiments, application of the one or more policies to the complete advertisement analyzes the tags associated with each advertisement component, and if a component is associated with a tag included in a blacklist, the advertisement is determined not to comply with a policy of the online system and is not presented to online system users. This also allows the online system to notify an advertiser of specific components of the advertisement that do not comply with a policy of the online system.

The features and advantages described in this summary and the following detailed description are not all-inclusive. Many additional features and advantages will be apparent to one of ordinary skill in the art in view of the drawings, specification, and claims.

### BRIEF DESCRIPTION OF THE DRAWINGS

FIG. 1 is a block diagram of a system environment for approving advertisements in an online system, in accordance with an embodiment of the invention.

FIG. 2 is a block diagram of a system architecture of an online system for approving advertisements, in accordance with an embodiment of the invention.

FIG. 3 is a flowchart of a process for approving advertisements in an online system, in accordance with one embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

An online system reviews advertisements against one or more policies. The advertisement review breaks advertisements (“ads”) into components (e.g., title, content, image, landing page, etc.). Rules from one or more policies are applied to each component of an advertisement to determine compliance with the rules. The online system also applies the complete rules from the policies applicable to the advertisement, allowing the online system to identify rules resulting in rejection of advertisements or components of the advertisement.

### System Environment

FIG. 1 is a diagram of one embodiment of a system environment for approving advertisements in an online system. FIG. 1 and the other figures use like reference numerals to identify like elements. A letter after a reference numeral, such as “120A,” indicates that the text refers specifically to the element having that particular reference numeral. A reference numeral in the text without a following letter, such as “120,” refers to any or all of the elements in the figures bearing that reference numeral (e.g., “120” in the text refers to reference numerals “120A” and/or “120B” in the figures).

Users 125a, 125b, 125c interact with the online system 101 using client devices 120a, 120b, 120c. A client device 120 may be any computing device having data processing and data communication capabilities. Examples of client devices 120 include a desktop computer, a laptop computer, a notebook, a tablet computer, a smart phone, a personal digital assistant (PDA), or any other suitable computing device.

In one embodiment, the online system 101, further described below in conjunction with FIG. 2, includes an external system interface 110 for transmitting and receiving data between the online system 101 and one or more client devices 120. The online system 101 maintains different types of objects representing data used for advertisement creation. Examples of objects maintained by the online system 101 include component rules 140, advertisement rules 150, advertisement objects 160, and approved advertisement objects 170. A component rule object 140 stores information describing identification of one or more components of an advertisement and determination of whether a component satisfies one or more policies of the online system 101. An advertisement rule object 150 stores information describing criteria for determining whether an advertisement satisfies one or more policies of the online system 101 based on whether components of the advertisement satisfy one or more policies of the online system 101. The advertisement objects 160 store information describing advertisements provided to the online system 101 from one or more advertisers. An approved advertisement object 170 includes information describing characteristics of an advertisement determined to satisfy at least a threshold number of policies of the online system 101 by an advertisement approval module 130. These objects are further described in detail herein.

### Online System Architecture

FIG. 2 is a block diagram of one embodiment of a system architecture of an online system 101 for approving advertisements. In the embodiment shown by FIG. 2, the online system 101 includes a web server 210, an external system interface 110, a user profile store 230, an advertisement store 240, and an advertisement approval module 130. In other embodiments, the online system 101 may include additional, fewer, or different modules for various applications. Conventional components such as network interfaces, security mechanisms, load balancers, failover servers, management and network operations consoles, and the like are not shown so as to not obscure the details of the system.

The online system 101 allows users to communicate or otherwise interact with each other and access content and stores user profile objects in the user profile store 230. Information stored in user profile store 230 describes the users of the online system 101, including biographic, demographic, and other types of descriptive information, such as work experience, educational history, gender, sexual preferences, hobbies or preferences, location, and the like.

The web server 210 links the online system 101 to one or more client devices 120 via a network 220; the web server 210 serves web pages, as well as other content, such as JAVA®, FLASH®, XML, and so forth. Additionally, the web server 210 may receive and route messages between the online system 101 and the client devices 210. These messages may be instant messages, queued messages (e.g., email), text and short message service (SMS) messages, or messages communicated using any other suitable messaging technique.

Interactions between the client devices 120 and the online system 101 are typically performed via a network 220. In one embodiment, the network 220 uses standard communications technologies and/or protocols. Thus, the network 220 may include communication channels using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Examples of networking protocols used on the network 220 include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. Data exchanged over the network 220 may be represented using technologies and/or formats including hypertext markup language (HTML), extensible markup language (XML), or any other suitable format. In addition, all or some of the communication channels may be encrypted using conventional encryption technologies such as secure sockets layer (SSL), transport layer security (TLS), virtual private networks (VPNs), Internet Protocol security (IPsec), etc. In another embodiment, custom and/or dedicated data communication technologies may be used in addition to, or instead of, those described above. Depending upon the embodiment, the network 220 may also include links to other networks such as the Internet.

The advertisement store 240 of the online system 101 stores information describing advertisements, such as advertisement objects 160 representing advertisements. Each advertisement object 160 is associated with a user account of an advertiser. An advertisement object 160 may be manually created through an interface provided by the online system 101. Alternatively, one or more advertisement objects 160 may be created by an advertiser using an application programming interface (API). An advertisement object 160 is reviewed for compliance with one or more policies of the online system 101 before being presented to online system users. In some embodiments, the advertisement store 240 stores advertisement objects 160 satisfying one or more policies of the online system 101 and removes advertisement objects 160 that do not satisfy a threshold number of policies of the online system 101 or that have been stored for greater than a threshold length of time. Other embodiments maintain advertisement objects 160 in the advertisement store 240 even if advertisement objects 160 do not satisfy one or more policies of the online system 101 or have been stored for greater than the threshold length of time.

The advertisement approval module 130 approves or rejects advertisement objects 160 based on whether components of advertisement corresponding to an advertisement object 160 satisfy one or more policies of the online system 101. In the embodiment shown by FIG. 2, the advertisement approval module 130 includes an advertisement divider module 260, a component review module 280, a component rule store 285, an advertisement review module 290, and an advertisement rule store 295. The advertisement approval module 130 is further described below.

### Advertisement Divider

The advertisement divider module 260 partitions an advertisement into one or more components. In one embodiment, the advertisement divider module 260 partitions an advertisement into one or more of: a title, a body, an image, a landing page, an audience, an account, and a campaign. The title provides a brief description of the advertisement. The body, or text, of an advertisement provides details about a product, service, or other content associated with the advertisement. The image is graphical data displayed by the advertisement. A landing page, or destination, is a web page, application, web site, or other network destination where a user is directed when accessing the advertisement. The audience component includes characteristics of users to be presented with the advertisement. An account component identifies the advertiser creating the advertisement. The campaign stores other information such as the timeframe during which an advertisement is presented, a budget for presenting the advertisement, the amount of money the online system 101 charges for presenting the advertisement to users, or other suitable information. In other embodiments, different and/or additional components may be generated from an advertisement.

### Advertisement Component Analysis

The component review module 280 determines information describing components of an advertisement. In some embodiments, the component review module 280 assigns tags from a pre-determined list of tags or “ground truths” stored in the component rule store 285 to advertisement components. A tag describes content, features, or attributes of an advertisement component. Hence, the tags describe characteristics of components of an advertisement. For example, an image including a picture of a beer mug may be tagged as “Alcohol Reference.”

As tags describe a component and do not specify whether a component satisfies a policy of the online system 101, if a policy changes, the tags associated with an advertisement object 160 may remain unchanged. Hence, in some embodiments, tags are policy independent. For example, if a policy in the online system 101 specifying rejection of advertisements related to paintball is removed, components identified as related to paintball remain tagged as “Paintball Reference.” In this example, when the advertisement approval module 130 reviews an advertisement object 160, the advertisement object 160 is not rejected for having the “Paintball Reference” tag, despite being rejected for having the “Paintball Reference” tag before the policy was removed.

In some embodiments, if analysis of a component is complex or if the component review module 280 determines the component needs further review, the component review module 280 may suggest manual review of the component. For example, the component review module 280 assigns a special tag, such as a “Needs More Review” tag to a component identified for manual review. In some embodiments, tags associated with a component by a human reviewer are differentiated from tags assigned to the component by the component review module 280. For example, if an image contains an alcohol reference, the component review module 280 assigns the tag “GT_ALCOHOL_REFERENCE” to the component and a human review assigns the tag “REP_ALCOHOL_REFERENCE” to the component.

In some embodiments, if the component review module 280 identifies a component for manual review, the component is sent to multiple human reviewers (e.g., five reviewers) instead of a single human reviewer. In one embodiment, a tag is associated with a component if at least a threshold number or percentage of the reviewers assign the tag to the component. For example, if four out of five reviewers tag an image as “Suitable for All” and a single reviewer tags the image as “Revealing Body Parts,” the image is assigned a tag of “Suitable for All.” In another embodiment, the threshold number or percentage of reviewers to assign a tag to a component may vary depending on the type of tag. Hence, each tag may be associated with a different threshold number or percentage depending on a risk factor associated with the tag. For example, if five reviewers analyze a component, the component review module 280 may assign a tag to a component having a medium risk factor if two of the five reviewers assign the tag to the component and may assign a tag to a component having a high risk factor if a single reviewer assigns the tag to the component.

In some embodiments, if a human reviewer cannot determine the most appropriate tag for a component, the component review module 280 assigns a tag requesting generation of a new tag to the component. For example, a “REP_NEED_BAD_TAG” tag may be associated with a component for which a tag cannot be identified. In one embodiment, the component review module 280 periodically reviews stored components associated with a “REP_NEED_BAD_TAG” tag to determine whether to create new tags.

### Advertisment Analysis

After the component review module 280 identifies characteristics of components of an advertisement, the advertisement review module 290 uses the characteristics of the components to determine whether the advertisement satisfies one or more policies of the online system 101. In some embodiments the advertisement review module 290 rejects an advertisement if any of its components is associated with a tag included on a blacklist. In other embodiments, an advertisement is rejected if at least a threshold number of components are associated with tags included on a blacklist.

In another embodiment, the advertisement review module 290 analyzes multiple characteristics of an advertisement's components to determine if the advertisement satisfies a policy of the online system 101. For example, the advertisement review module 290 rejects an advertisement including an image tagged as “Alcohol Reference” and includes a target audience of “All.” However, if another advertisement includes an “Alcohol Reference” tagged image and the target audience is identified as “Over 21,” the advertisement is determined to satisfy a policy of the online system 101. In another embodiment, the advertisement review module 290 approves an advertisement including an auto-approve tag associated with a component, regardless of tags associated with other components of the advertisement.

For example, the advertisement review module 290 retrieves a policy from the advertisement rule store 295, which stores one or more policies having rules for advertisement components. The policy included in the advertisement rule store 295 includes one or more rules for application to various components of an advertisement. The advertisement review module 290 applies various rules from a policy to components of the advertisement. Hence, a policy includes a complete set of rules applicable to various components of an advertisement. The advertisement review module 290 retrieves a policy relevant to an advertisement from the advertisement rule store 295 and applies rules from the policy to components of the advertisement to determine if the advertisement complies with the policy.

In some embodiments, if an advertisement is rejected, the advertisement approval module 130 sends a message notifying the advertiser creating the advertisement that the advertisement does not satisfy a policy of the online system 101. For example, a disapproval email identifying characteristics of an advertisement that did not satisfy a policy of the online system or describing the rules of a policy that an advertisement did not satisfy is sent to an advertiser. The disapproval message may also include a list of tags assigned to each component and suggestions for improving the advertisement.

FIG. 3 shows a flowchart of a method for reviewing advertisements in an online system 101. The advertisement approval module 130 receives 310 an advertisement for review via an interface for advertisement creation, such as a web page or an application programming interface (API). The advertisement divider module 260 divides 320 the advertisement into one or more components. For example, the advertisement divider module 260 divides 320 the advertisement into a title, a body, an image, a landing page, an account identifier, or other suitable information.

A component of the advertisement is selected 325, and the component review module 280 applies 335 one or more component rules for associating one or more tags with the selected component. After associating one or more tags with the component, the advertisement approval module 130 determines 350 if the advertisement includes additional components. If the advertisement includes additional components, an additional component is selected 325 and the preceding steps are repeated for the additional component. If no additional components are included in the advertisement, the advertisement review module 290 applies 360 one or more advertisement rules to the components of the advertisement to determine if the advertisement satisfies one or more policies of the online system 101. As described above, tags associated with various components of an advertisement are compared to various rules selected from an advertisement policy to determine if the components satisfy the advertisement policy. For example, if at least a threshold number of components of the advertisement satisfy a policy of the online system 101, the advertisement is determined to satisfy the policy of the online system 101 and may be presented by the online system 101. As another example, if a single component of the advertisement does not satisfy the policy of the online system 101, the advertisement is determines to not satisfy the policy and is not presented.

### SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer implemented method comprising:
receiving, at an online system, an advertisement from an advertiser;
dividing the advertisement into a plurality of components;
for each of the plurality of components of the advertisement, determining one or more tags describing characteristics of the components;
retrieving a policy including one or more advertisement rules;
determining whether the advertisement satisfies the policy by determining if one or more components of the advertisement satisfy one or more advertisement rules from the policy associated with a component based on the one or more tags associated with the component.

2. The computer implemented method of claim 1, wherein determining whether the advertisement satisfies the policy by determining if one or more components of the advertisement satisfy one or more advertisement rules from the policy associated with the component based on the one or more tags associated with the component comprises:
determining the advertisement satisfies the policy of the online system if at least a threshold number of the plurality of components satisfy the policy of the online system based on the one or more tags.

3. The computer implemented method of claim 1, wherein the one or more tags describing characteristics of the components are independent of the policy of the online system.

4. The computer implemented method of claim 1, wherein determining whether the advertisement satisfies the policy by determining if one or more components of the advertisement satisfy one or more advertisement rules from the policy associated with the component based on the one or more tags associated with the component comprises:
determining the advertisement does not satisfy the policy of the online system if at least one of the tags is included on a blacklist.

5. The computer implemented method of claim 1, wherein determining whether the advertisement satisfies the policy by determining if one or more components of the advertisement satisfy one or more advertisement rules from the policy associated with the component based on the one or more tags associated with the component comprises:
determining the advertisement satisfies the policy of the online system if at least one of the tags indicates an automatic approval.

6. The computer implemented method of claim 1, wherein a component is selected from a group consisting of: a title, a body, an image, a landing page, an audience description, an account identifying the advertiser, and any combination thereof.

7. The computer implemented method of claim 1, wherein a component is selected from a group consisting of: a timeframe for presenting the advertisement, a budget for presenting the advertisement, an amount charged to the advertiser for presentation of the advertisement, and any combination thereof.

8. The computer implemented method of claim 1, further comprising:
presenting the advertisement to users of the online system in response to determining the advertisement satisfies the policy of the online system.

9. The computer implemented method of claim 1, further comprising:
providing a message to the advertiser indicating whether the advertisement satisfies the policy.

10. The computer implemented method of claim 9, wherein the message identifies one or more components of the advertisement that did not satisfy an advertisement rule.

11. A computer implemented method comprising:
receiving, at an online system, an advertisement from an advertiser;
dividing the advertisement into a plurality of components, each component associated with one or more tags describing characteristics of the component;
determining whether the advertisement satisfies a policy of the online system based on by the one or more tags associated with components of the advertisement.

12. The computer implemented method of claim 11, wherein determining whether the advertisement satisfies a policy of the online system based on by the one or more tags associated with components of the advertisement comprises:
determining the advertisement satisfies the policy of the online system if at least a threshold number of the plurality of components satisfy the policy of the online system based on the one or more tags.

13. The computer implemented method of claim 13, wherein the one or more tags describing characteristics of the components are independent of one or more policies of the online system.

14. The computer implemented method of claim 11, wherein determining whether the advertisement satisfies a policy of the online system based on by the one or more tags associated with components of the advertisement comprises:
determining the advertisement does not satisfy the policy of the online system if at least one of the tags is included on a blacklist.

15. The computer implemented method of claim 11, wherein determining whether the advertisement satisfies a policy of the online system based on by the one or more tags associated with components of the advertisement comprises:
determining the advertisement satisfies the policy of the online system if at least one of the tags indicates an automatic approval.

16. The computer implemented method of claim 11, wherein a component is selected from a group consisting of: a title, a body, an image, a landing page, an audience description, an account identifying the advertiser, and any combination thereof.

17. The computer implemented method of claim 11, wherein a component is selected from a group consisting of: a timeframe for presenting the advertisement, a budget for presenting the advertisement, an amount charged to the advertiser for presentation of the advertisement, and any combination thereof.
